(19) United States
(12) Patent Application Publication
(10) Pub. No.: US 2011/0227949 A1
(43) Pub. Date: Sep. 22, 2011

(54) READ APPARATUS AND OPERATION METHOD FOR E-BOOK

(75) Inventors: Gary Kung, Santa Ana, CA (US); Ping-Shun Zeung, Santa Ana, CA (US)

(73) Assignee: I/O INTERCONNECT, LTD., Santa Ana, CA (US)

(21) Appl. No.: 13/025,803

(22) Filed: Feb. 11, 2011

Related U.S. Application Data
(60) Provisional application No. 61/315,416, filed on Mar. 19, 2010.

(51) Int. Cl. G09G 5/00

(52) U.S. Cl. 345/660

(57) ABSTRACT

A read apparatus provided by the present invention has a screen, a storage unit and a processing module. The storage unit saves at least one e-book having a plurality of pages. Wherein, the processing module is coupled to the screen and storage unit. Therefore, the processing module can display the e-book on the screen, so as to responde a read request. Meanwhile, when the word size of the e-book has been adjusted, the processing module maintains original contents corresponding to each of pages in e-book for responding a browse request.

### CROSS-REFERENCE TO RELATED APPLICATION

This application claims the priority benefit of U.S. application Ser. No. 61/315416, filed on Mar. 19, 2010. The entirety of the above-mentioned patent application is incorporated herein by reference and made a part of this specification.

### BACKGROUND

1. Technical Field

The present invention generally relates to an e-book and particularly, to an operation method for index information of the e-book.

2. Description of the Related Art

Along with the development of the technical and the popularization of network information, each kind of language as well as the image data also grows day by day. So that the conventional read mode has a great influence and impact. If the huge quantity image data is used conventional printing way dissemination, its volume and quantity are quite astonishing. It is inconvenient on carrying, reading or preserving, and expensive on paying the ecology cost. Therefore, with the digital time coming, developing the e-book having such characters which comprises carrying many volumes of publication documents once time, the content being searchable, downloading from the network directly, obtaining the book easily, decreasing great cost of printing and mailing is necessary.

Thus, many kinds of relative electric read apparatuses are also developed, so as to assist the user processing information without time and space limitations. These electric read apparatuses have several characters such like that the size is appropriate as a normal book, conforms the user's read habit, carries easily, has ability for saving great volume books as a small library, has high resolution, has a battery with long using time, displays image clearly, allows user to read under any light source, downloads articles with digital copyright form internet or computer, has perfect digital copyright security system, and guarantees the copyright being not pirated infringement.

Although many kinds of electric read apparatuses can be chosen, a big problem of current electric read apparatuses is whether or not the operation means conforming user's habit so as to let user operates convenient.

### BRIEF SUMMARY

Therefore, the present invention provides a read apparatus and an operation method for an e-book, which can make a user operates the e-book more easily.

A read apparatus provided by the present invention comprises a screen, a storage unit and a processing module. The storage unit saves at least one e-book having a plurality of pages. Wherein, the processing module is coupled to the screen and storage unit. Therefore, the processing module can display the e-book on the screen, so as to responde a read request. Meanwhile, when the word size of the e-book has been adjusted, the processing module maintains original contents corresponding to each of pages in e-book for responding a browse request.

From another viewpoint, an operation method for an e-book is provided by the present invention, wherein the e-book has a plurality of pages. The operation method of the present invention comprises showing a tool menu on an e-book screen as displaying the e-book on a screen, wherein the tool menu has a plurality of tool for performing a plurality of edition procedures with the e-book, so as to responde a plurality of edition requests. Furthermore, when the word size of the e-book is adjusted, the present invention would maintain original contents corresponding to each of pages in the e-book for responding a browse request.

In one of embodiments of the present invention, the said edition requests include editing notes, inserting bookmarks, insert memo, and adjusting word size.

Furthermore, the present invention can share all edition procedures and edition contents of the e-book to another same e-book for responding a share request. Therefore, both of e-books with the same contents have the same edition procedures and edition contents.

Since the present invention can maintain original of each of pages in the e-book as adjusting word size of the e-book. Therefore, the present invention can solve reading puzzle. In addition, the e-book of the present invention has ability for sharing edition procedures and edition contents to another one, so as to increase convenient.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system block diagram of a read apparatus according to one preferred embodiment of the present invention.

FIG. 2 shows a diagram of a screen of the e-book according to one preferred embodiment of the present invention.

FIG. 3 shows a flow chart diagram of an operation method for an e-book according to one preferred embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

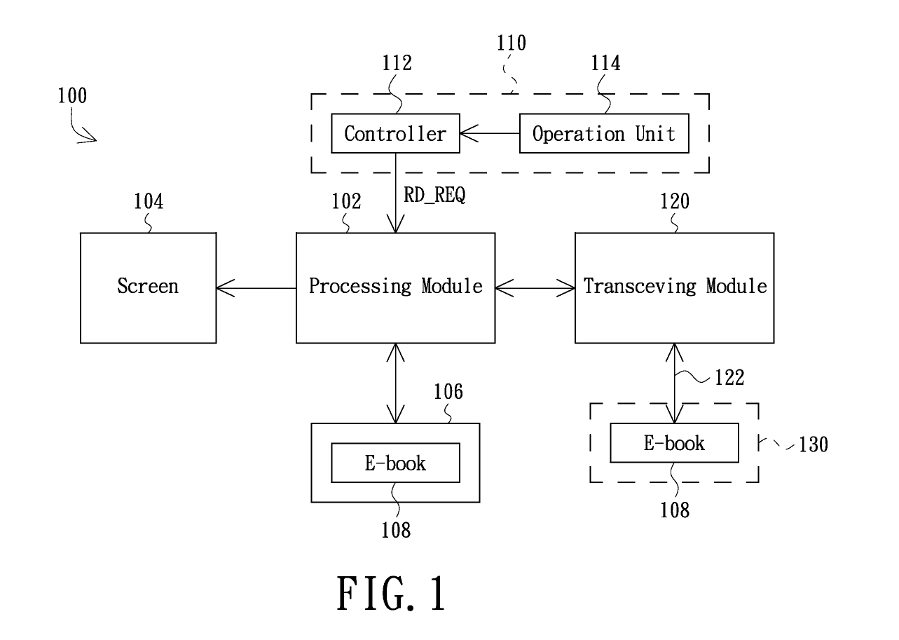

FIG. 1 shows a system block diagram of a read apparatus according to one preferred embodiment of the present invention. Referring FIG. 1, the read apparatus 100 provided by the present embodiment comprises a processing module 102 coupled to a screen 104 and storage unit 106. The screen 104 is probably a normal LCD display panel, or a bi-stable display panel such as electrophoretic displayer. In addition, the screen 104 can be implemented by a touch control display panel.

The storage unit 106 is probably an external storage device, such a memory card, a USB storage device, an optical storage media, etc. Of course, the storage unit 106 is further implemented by build-in storage device, like a hard disk, a flash memory, etc. In the present embodiment, an e-book 108 is saved in the storage unit 106. Wherein, the e-book 108 has a plurality of pages, and each of the pages is corresponding to one of a plurality of page numbers respectively. Furthermore, each page has a predetermined length.

Referring FIG. 1 continually, in present embodiment, the read apparatus 100 further has an operation module 110 coupled to the processing module 102. The operation 110 includes a controller 112 and at least one operation unit 114. Wherein, the operation unit 114 is at least one of a real press key, a joy stick, a touch control panel, trace ball, which is coupled to the controller 112. When user operates the operation unit 114 to vary the status of the operation unit 114, the controller 112 outputs corresponding control signal to the processing module 102 according to the status of the operation unit 114. Meanwhile, the processing module 102 controls the read apparatus 100 according to the control signal.

For example, when the user operates the operation module 110 to generate a read request RD_REQ, the processing unit 102 obtains the e-book 108 from the storage unit 106, and displays the e-book 108 on the screen 104.

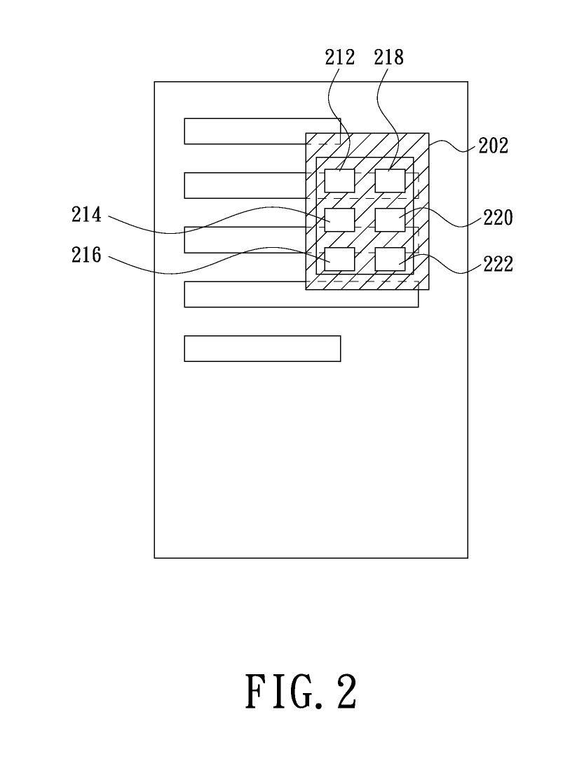

FIG. 2 shows a diagram of a screen of the e-book according to one preferred embodiment of the present invention. Referring FIGS. 1 and 2, in the present embodiment, a e-book screen is generated as displaying the e-book 108 on the screen 104 shown as 200. Viewing from FIG. 2, an edition menu 202 is further shown on e-book screen 200, wherein the edition menu 202 has a plurality of edition tools such as 212, 214, 216, 218, 220, and 222. These edition tools 212, 214, 216, 218, 220, and 222 are used for performing corresponding edition procedures with the e-book 108, such editing note, inserting bookmark, inserting memo, and adjusting word size for responding to a plurality of edition requests.

For example, in present embodiment, the edition tool 212 corresponds to one of the edition requests of editing note. Thus, when a user enable the edition tool 212 as touching edition tool 212 on touch control screen, the corresponding edition request of editing note is generated. Meanwhile, the user can input note in the corresponding page of e-book 108.

Furthermore, in some embodiments, the edition menu 202 is shown on the e-book screen 202 with semitranslucent mode.

When the user edits one of pages of e-book 108 such varying word size of e-book 108, the contents corresponding to each of pages may be change, so as to course some communication problems.

For example, when users A and B have the same e-book, and the users A and B varies word size of the e-book respectively, the contents of each of pages with the same page number in two e-books of users A and B may be different. Therefore, when users A and B discuss one of pages of the e-books, the users A and B may have misunderstanding with each other because of different contents in two pages with the same page number. A real situation is used for explaining the above problem as flowing.

In this real situation, the users A and B have the same e-books and discuss the contents of page 5 of two e-books. Since the user A increases the word size of corresponding e-book, the content of page 4 may extend to page 5 of user A's e-book. In another word, the current content of page 5 of user A's e-book is actually a portion of original content in page 4 of user A's e-book. Furthermore, the user B may reduce the word size of corresponding e-book, so as to cause a portion of original content of page 6 moves to page 5. Therefore, the current content of page 5 of user B's e-book is actually a portion of original content of page 6 of user B's e-book.

However the e-book 108 provided by the present embodiment, further has a browse tool, such as edition tool 214, so that the above problem is solved. In the present embodiment, the browse tool of e-book 108 maintains the original contents of each of pages as the word size of the e-book being adjusted, for responding a browsing request. Therefore, even different users edit the same e-book, the contents of each of the pages with the same page number are the same.

In other embodiments, the browse may be a firmware, and be written in the processing module 102. Therefore, the processing module 102 maintains the original contents corresponding to each of pages of e-book 108 as the word size of e-book 108 being adjusted, for responding to the browsing request.

Referring to FIG. 1 again, the read apparatus 100 further comprises a transceiver module 120 coupled to processing module 102. The transceiver module 120 links to a host apparatus 130 through a data transmission interface 122. Wherein, the data transmission interface 122 is probably a wire transmission interface, such as USB interface. In other embodiments, data transmission interface 122 is probably a wireless transmission interface, like infrared transmission interface or Bluetooth transmission interface, etc.

Furthermore, there is a share tool, such as edition tool 216, in the e-book 108. When the host apparatus 130 has another e-book 108, a user can enable the share tool for sharing the edition procedures and edition contents of the e-book 108 saved in the storage unit 106 to the e-book 108 saved in the host apparatus 130. Therefore, both of the e-book 108 saved in the host apparatus 130 and the e-book 108 saved in the storage unit 106 has the same edition procedures and edition contents. For example, when the user edits notes, inserts memo, or marks point on the e-book 108 saved in the storage unit 106, these edition procedures and edition contents, such as contents of notes and memo, can be shared with the e-book 108 saved in the host apparatus 130 by the share tool.

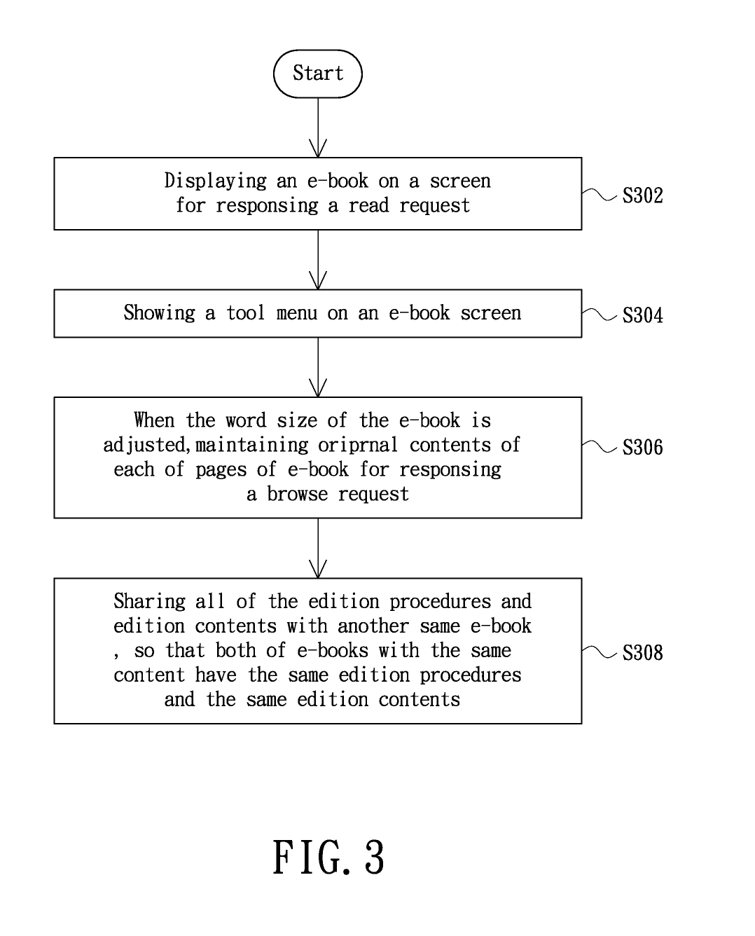

FIG. 3 shows a flow chart diagram of an operation method for an e-book according to one preferred embodiment of the present invention. Referring FIG. 3, the operation method provided by the present embodiment is that displays the e-book on a screen for responding a read request (step S302). Wherein, the e-book has a plurality of pages. When the e-book is displayed on the screen, a tool menu is shown on the e-book screen (step S304). The tool menu has a plurality of edition tools for performing corresponding edition procedures with the e-book, so as to responde different edition requests.

When the word size of the e-book is adjusted, the present embodiment would maintain original contents corresponding to each of the pages for responding a browsing request (step S306). In some embodiments, the e-book further has a share tool, which can share all edition procedures and edition contents of the e-book with another same e-book for responding a share request (step S308). Therefore, both of the e-books with the same contents can have the same edition procedures and edition contents.

In summary, the user can read the e-book provided by the present invention more convenience because of the browse tool and the share tool. Furthermore, the user can share the edition procedures and edition contents to another one easily.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A read apparatus, comprising:
a storage unit, saving at least one e-book having a plurality of pages;
a processing module, coupled to the storage unit for obtaining the e-book, so as to responde a read request; and
a screen, coupled to the processing module for displaying the e-book.
wherein the processing module maintains original contents of each of the pages as the word size of the e-book being adjusted, so as to responde a browsing request, when the e-book is displayed on the screen.

2. The read apparatus as claimed in claim 1, further comprising an operation module coupled to the processing module for outputting a control signal to the processing module according to a user's operation, so that the processing module controls the read apparatus according to the control signal.

3. The read apparatus as claimed in claim 1, further comprising a transceiver module coupled to a host apparatus through a data transmission interface, and the e-book having a share tool, when the share tool is enabled, and the same e-book is also saved in the host apparatus, all edition procedures and edition contents of the e-book saved in the read apparatus are shared with the e-book saved in the host apparatus, so that the e-book saved in the host apparatus has the same edition procedures and edition contents with the e-book saved in the read apparatus.

4. An operation method for an e-book, wherein the e-book has a plurality of pages, and the operation method comprises:
showing a tool menu on a screen of the e-book as displaying the e-book on the screen,
wherein the tool menu has a plurality of edition tool for performing corresponding edition procedures with the e-book for responding a plurality of edition requests;
maintaining original contents corresponding to each of the pages as the word size of the e-book being adjusted, so as to responde to a browsing request.

5. The operation method as claimed in claim 4, wherein the edition requests comprises editing notes, inserting bookmarks, inserting memo, and adjusting the size of words.

6. The operation method as claimed in claim 4, further comprising sharing all edition procedures and edition contents in the e-book to another same e-book for responding a share request, so that the another same e-book has the same edition procedures and edition contents.

7. The operation method as claimed in claim 4, wherein the tool menu is shown on the screen of the e-book with semitranslucent mode.
